(19) United States
(12) Patent Application Publication
(10) Pub. No.: US 2005/0053343 A1
(43) Pub. Date: Mar. 10, 2005

(54) Optical fiber cable for access network

(76) Inventor: Ho-Soon Lee, Taegukwangyok-shi (KR)

Correspondence Address: CHA & REITER, LLC, 210 ROUTE 4 EAST STE 103, PARAMUS, NJ, 07652, US

(21) Appl. No.: 10/686,818

(22) Filed: Oct. 16, 2003

(30) Foreign Application Priority Data
Nov. 7, 2002 (KR) 2002-68848

(51) Int. Cl. G02B 6/44

(52) U.S. Cl. 385/114

(57) ABSTRACT

Disclosed is an optical fiber cable for an access network and includes: a ribbon optical fiber bundle formed by stacking a plurality of ribbon optical fibers, each of which comprises a plurality of optical fibers arranged in parallel and a jacket coated around the optical fibers; a plurality of tension members arranged in parallel along the longitudinal direction, so that they are brought into close contact with the ribbon optical fibers; and, an outer sheath extruded and coated around the ribbon optical fiber bundle and the tension members.

### CLAIM OF PRIORITY

This application claims priority to an application entitled “Optical Fiber Cable for Access Network,” filed with the Korean Intellectual Property Office on Nov. 7, 2002 and assigned Serial No. 2002-68848, the contents of which are hereby incorporated by reference.

### BACKGROUND OF THE INVENTION

1. Field of the Invention

The present invention relates to an optical fiber cable comprising one or more optical fibers, and in particular to an optical fiber cable used between an access network and an end subscriber.

2. Description of the Related Art

In general, a passive-optical-network (PON) is an access network made of a tree-structured topology by connecting one optical-line-termination (OLT) to a plurality of optical network lines (ONU) using a 1×N optical distribution network (ODN).

FIG. 1 is a cross-sectional view illustrating the construction of a conventional optical fiber cable used in an access network. As shown, the conventional optical fiber cable comprises: a central tension member 110 centrally disposed in the optical fiber cable, a reinforcing layer 120 enclosing the central tension member 110, a plurality of loose tubes 140 distributed around the reinforcing layer 120, wherein a multi-optical fiber array 130 is housed within each of the loose tubes 140, an outer sheath 150 provided at the outermost area of the optical fiber cable, and a plurality of rip cords 160 for facilitating the labor of peeling the optical fiber cable. The optical fiber cable has a multi-loose tube construction in order to house one or more multi-optical fiber arrays.

FIG. 2 is a cross-sectional view illustrating the construction of another conventional optical fiber cable used in an access network. As shown, the conventional optical cable comprises: a loose tube 230 for housing a multi-optical fiber array 210, jelly 220 filled in the space between the loose tube 230 and the multi-optical fiber array 210, a glass yarn layer 240 enclosing the outer circumference surface of the loose tube 230, and an outer sheath 250 provided at the outermost area of the optical fiber cable. The jelly 220 serves to protect the multi-optical fiber array 210 from external impacts and to block moisture which has penetrated into and exists in the loose tube. The glass yarn layer 240 functions to increase the mechanical strength and tension-resistance of the optical fiber cable.

FIG. 3 is a cross-sectional view illustrating yet another conventional optical fiber cable used in an access network. As shown, the conventional optical fiber cable comprises: a plurality of tightly coated optical fibers 310, an outer sheath 330 provided at the outermost area of the optical fiber cable, and a tension member 320 filled inside the outer sheath 330. The tightly coated optical fibers 310 each consist of a core, a clad, and a tight-coating layer. The tension member 320 performs a shock absorbing function when an external pressure is exerted on the optical fiber cable. The outer sheath 330 is formed by an extrusion process around the outermost area in order to protect the interior of the sheath from the external environment.

To be implemented in an access network, an optical fiber cable is typically required to have a small number of optical fibers that is light to facilitate an efficient usage of the space. However, the conventional optical fiber cables as described above do not meet with these requirements. Moreover, the conventional optical fiber cable equipped with a filling material, such as jelly, provided in the loose tube poses a problem in that the process of pulling installation required for such installation is a difficult.

Therefore, there is a need for an improved optical fiber cable arrangement that is compact and light.

### SUMMARY OF THE INVENTION

The present invention overcomes the above-described problems, and provides additional advantages, by providing an optical fiber cable applicable in an access network that has a small diameter and a light weight.

According to one aspect of the invention is to provide an optical fiber cable used in an access network which includes: a ribbon optical fiber bundle formed by stacking a plurality of ribbon optical fibers, each of which including a plurality of optical fibers arranged in parallel and a jacket coated to wrap the optical fibers; a plurality of tension members arranged in parallel along the longitudinal direction, so that the tension members are brought into close contact with the ribbon optical fibers; and, an outer sheath extruded and coated around the ribbon optical fiber bundle and the tension members.

Still another aspect is that the present invention may be realized in a simple, reliable, and inexpensive implementation.

### BRIEF DESCRIPTION OF THE DRAWINGS

The above features and advantages of the present invention will be more apparent from the following detailed description taken in conjunction with the accompanying drawings, in which:

FIG. 1 is a cross-sectional view illustrating the construction of a conventional optical fiber cable for an access network;

FIG. 2 is a cross-sectional view illustrating the construction of another conventional optical fiber cable for an access network;

FIG. 3 is a cross-sectional view illustrating the construction of yet another conventional optical fiber cable for an access network;

FIG. 4 is a cross-sectional view illustrating the construction of an optical fiber cable for an access network according to a first preferred embodiment of the present invention; and,

FIG. 5. is a cross-sectional view illustrating the construction of an optical fiber cable for an access network according to a second preferred embodiment of the present invention.

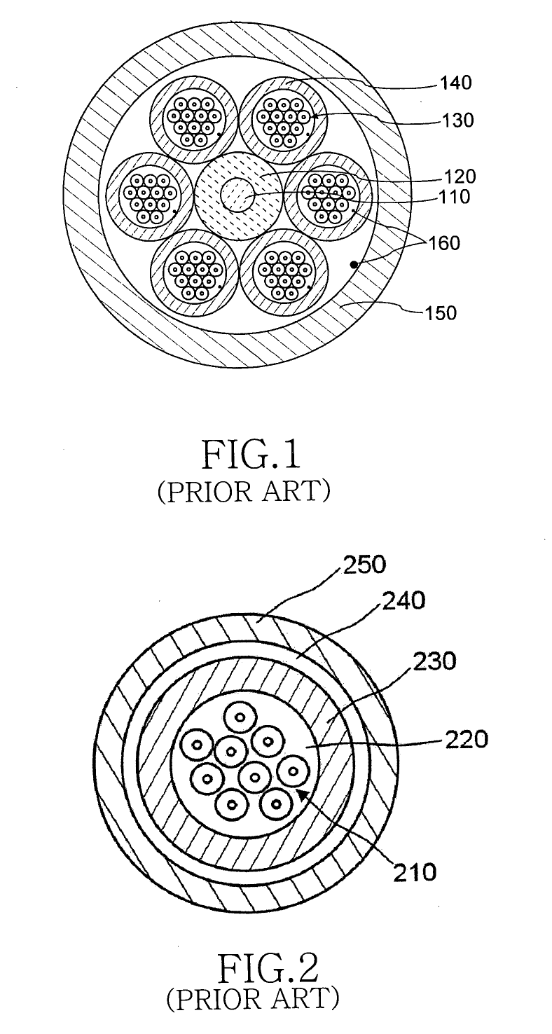

### DETAILED DESCRIPTION OF THE PREFERRED EMBODIMENTS

Hereinafter, preferred embodiments of the present invention will be described with reference to the accompanying drawings. For the purposes of clarity and simplicity, a detailed description of known functions and configurations incorporated herein will be omitted as it may make the subject matter of the present invention rather unclear.

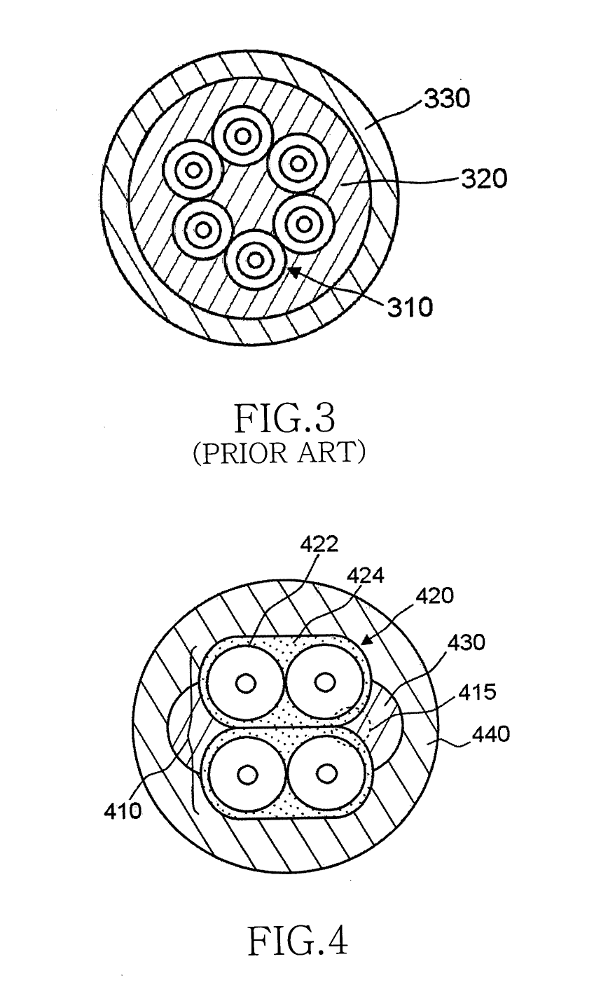

FIG. 4 is a cross-sectional view illustrating the construction of an optical fiber cable used in an access network according to a first preferred embodiment of the present invention. As shown, the optical fiber cable of the first embodiment comprises an arrayed ribbon optical fiber bundle 410, a plurality of tension members 430, and an outer sheath 440.

The ribbon optical fiber bundle 410 has a construction in which a plurality of ribbon optical fibers 420 are stacked, and each ribbon optical fibers 420 includes a plurality of optical fibers 422 arranged in parallel, and a jacket coated around the optical fibers 422. Each optical fibers 422 includes a core, which serves as a transmission carrier for optical signals, and a cladding for enclosing the core. The jacket 424 may be formed from a polymeric compound, such as UV-curable resin, polyvinyl chloride (PVC), Hytrel, Nylon, polyethylene (PE), polyester, polyolefin, and etc.

The tension members 430 are longitudinally arranged in parallel and are in close contact with the ribbon optical fiber bundle 410. The tension members 430 are formed symmetrically with reference to the ribbon optical fiber bundle 410. The tension members 430 function to resist against the pulling tension produced in the process of installing the optical fiber cable. Each of the tension members 430 is in close contact with a valley 415, formed by the external circumferential surface of the ribbon optical fiber bundle 410, so that the tension members 430 function additionally to block the passage of moisture within the optical fiber cable. The tension members 430 may be formed from aramid yarn, glass yarn, glass fiber-reinforced plastic (FRP) or the like.

The outer sheath 440 is extruded and coated to surround the optical fiber ribbons 410 and the tension members 430, thereby mechanically and environmentally protecting the ribbon optical fiber bundle 410. The outer sheath 440 may be formed from a polymeric material such as PVC, polyolefin, PE, polyamide, Polybutylene Terephthalate (PBT) or the like. Further, the outer sheath 440 may be formed from a frame-retardant material as a countermeasure against fire.

Note that the optical fiber cable may further comprise one or more rip cords located adjacent to the outer sheath 440, so that the optical fiber ribbons 410 may be easily stripped after the installation of the optical fiber cable.

The inventive optical fiber cable as described above has an outer diameter of not more than 3.0 mm and a weight of not more than 10 kg/km, so that to the inventive cable allows to increase the integrated capacitance of optical fibers and to reduce the costs of installation as compared to the conventional optical fiber cables.

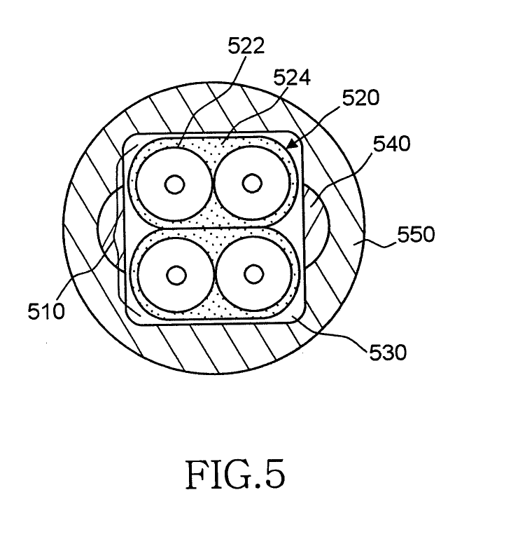

FIG. 5 is a cross-sectional view illustrating the construction of an optical fiber cable used in an access network according to a second preferred embodiment of the present invention. As shown, the optical fiber cable of the second embodiment comprises an arrayed ribbon optical fiber bundle 510, one or more binders 530, a tension member 540, and an outer sheath 550.

The arrayed ribbon optical fiber bundle 510 has a construction in which a plurality of ribbon optical fibers 520 are stacked. Each ribbon optical fibers 520 includes a plurality of optical fibers 522 arranged in parallel, and a jacket 524 coated to wrap the optical fibers 522. Each optical fibers 522 includes a core, which serves as a transmission carrier for optical signals, and a cladding enclosing the core.

The binders 530 may be inserted along the longitudinal direction of the ribbon optical fiber bundle 510 or wound around the ribbon optical fiber bundle 510. The binders 530 function to maintain the shape of the ribbon optical fiber bundle 510 and may be formed of thread or tape material. In the case where the binder 530 is in the form of thread, it may be formed from aramid yarn or polyester, whereas in the case where the binder 530 is in the form of tape, it may be formed from a polymeric compound such as polyester, Polypropylene (PP) or the like.

The tension members 540 are longitudinally arranged in parallel to be in close contact with the optical fiber ribbons 530 and are formed symmetrically with reference to the ribbon optical fiber ribbon bundle 510.

The outer sheath 550 is extruded and coated around the ribbon optical fiber bundle 510, the binders 530, and the tension members 530, thereby mechanically and environmentally protecting the ribbon optical fiber bundle 510.

Note that the optical fiber cable may further comprise one or more rip cords located adjacent to the outer sheath 550, so that the ribbon optical fiber bundle 510 may be easily stripped after the installation of the optical fiber cable.

The inventive optical fiber cable as described above has an outer diameter of not more than 3.5 mm and a weight of not more than 15 kg/km, so that the inventive cable allows to increase the integrated capacitance of optical fibers and to reduce the costs of installation as compared to the conventional optical fiber cables.

As described above, the optical fiber cable according to the present invention has an advantage in that it is possible to enhance the integrated capacitance of optical fibers and reduce the costs of the installation when compared to the conventional optical fiber cables in identical installation circumstances. Furthermore, the optical fiber cable according to the present invention is highly resistant to the external environment as it has one or more tension members and an outer sheath supporting such function. Therefore, it is easy to branch an optical fiber when required and also possible to reduce the costs for branching.

While the invention has been shown and described with reference to certain preferred embodiments thereof, it will be understood by those skilled in the art that various changes in form and details may be made therein without departing from the spirit and scope of the invention as defined by the appended claims.

1. An optical fiber cable comprising:
a ribbon fiber bundle formed by stacking a plurality of ribbon optical fibers, each of the plurality of ribbon optical fibers comprises a plurality of optical fibers arranged in parallel and a jacket surrounding the plurality of optical fibers;
a plurality of tension members arranged in parallel and in a close contact relationship along a longitudinal direction of the ribbon fiber bundle; and,
an outer sheath surrounding the ribbon optical fiber bundle and the tension members.

2. The optical fiber cable according to claim 1, wherein the tension members are in contact with an intersection area between the external circumferential surfaces of the plurality of ribbon optical fibers, defining valleys.

3. The optical fiber cable according to claim 1, wherein the optical fiber cable has a diameter substantially less than 3.0 mm.

4. The optical fiber cable according to claim 1, wherein the optical fiber cable has a weight substantially less than 10 kg/km.

5. The optical fiber cable according to claim 1, wherein the jacket is formed of a polymeric compound.

6. The optical fiber cable according to claim 5, wherein the polymetric compound is selected from a group consisting of UV-curable resin, polyvinyl chloride (PVC), Hytrel, Nylon, polyethylene (PE), polyester, and polyolefin.

7. The optical fiber cable according to claim 1, wherein the tension members are formed from one of aramid yarn, glass yarn, glass fiber-reinforced plastic (FRP) material.

8. The optical fiber cable according to claim 1, wherein the outer sheath is formed from a polymeric material.

9. The optical fiber cable according to claim 1, wherein the polymetric material is selected from a group consisting of PVC, polyolefin, PE, polyamide, Polybutylene Terephthalate (PBT).

10. The optical fiber cable according to claim 1, wherein the outer sheath is formed from a frame-retardant material.

11. An optical fiber cable comprising:
a ribbon fiber bundle formed by stacking a plurality of ribbon optical fibers, each of the plurality of ribbon optical fibers comprises a plurality of optical fibers arranged in parallel and a jacket surrounding the plurality of optical fibers;
at least one binder for binding the ribbon optical fiber bundle;
a plurality of tension members arranged in parallel and in a close contact relationship with the binders; and,
an outer sheath surrounding the ribbon optical fiber bundle, the binder, and the tension members.

12. The optical fiber cable according to claim 11, wherein the binder is a tape made from a polymeric compound.

13. The optical fiber cable according to claim 11, wherein the optical fiber cable has a diameter substantially less than 3.0 mm.

14. The optical fiber cable according to claim 11, wherein the optical fiber cable has a weight substantially less than 10 kg/km.
